(19) United States
(12) Patent Application Publication
(10) Pub. No.: US 2023/0386034 A1
(43) Pub. Date: Nov. 30, 2023

(54) USE OF DYNAMIC ANALYTICAL SPECTRA TO DETECT A CONDITION

(71) Applicant: SIGNIFY HOLDING B.V., EINDHOVEN (NL)

(72) Inventors: MARC ANDRE DE SAMBER, LOMMEL (BE); AARON BENJAMIN STEPHAN, Chanhassen, MN (US); HARRY BROERS, 's-Hertogenbosch (NL)

(21) Appl. No.: 18/032,747

(22) PCT Filed: Oct. 15, 2021
(86) PCT No.: PCT/EP2021/078566

§ 371 Date: Apr. 19, 2023

Related U.S. Application Data
(60) Provisional application No. 63/093,487, filed on Oct. 19, 2020.

(30) Foreign Application Priority Data
Oct. 26, 2020 (EP) 20203745.3

(51) Int. Cl. G06T 7/00

(52) U.S. Cl. CPC G06T 7/0014; G06T 2207/30004

(57) ABSTRACT

A method and system for detection and alerting of a known condition within an environment. The systems and methods obtain a plurality of reference images from a plurality of samples under known conditions, provide each of the plurality of reference images to an image recognition algorithm and generate a historical database of reference images to be used in real-time. The system can obtain real-time samples, render spectral ages of the sample's composition, and use the image recognition algorithm to compare the overall shape of the image to the overall shapes in the reference images to determine if they match to within a threshold value. Upon a positive determination that the images match within a threshold value, an alert can be sent to the supervisor of an environment to warn them of the onset of a known condition. In some examples, counter-measures can be employed to alleviate certain known conditions.

### FIELD OF THE DISCLOSURE

The present disclosure is directed generally to detecting the onset of a condition within an environment, specifically to the use of dynamic analytical spectra to detect the onset of a condition.

### BACKGROUND

Advancements in miniaturization of analysis tools, e.g., gas chromatography systems, allow for use into non-laboratory settings. Also, miniaturization of these tools typically leads to a large reduction in cost, further enabling wider use. Analysis of spectrograms produced by these systems and tools allows for detection of certain compounds and elements present within a given sample. Interpreting these spectrograms is becoming increasingly difficult. For example, certain inquiries utilize low detection limits, e.g., sub parts-per-billion level. Additionally, there are a multitude of compounds that can be detected at once in a single spectrogram and detected compounds often overlap within a given spectrum such that identifying and quantifying these compounds requires deep knowledge and complex post-processing.

Biomarkers, or other critical indicators, in animal and plant environments are becoming better understood, however relating biomarkers and their concentrations to certain conditions remains difficult and often impossible.

### SUMMARY OF THE DISCLOSURE

The present disclosure relates to methods and systems for detection and alerting of a known condition within an environment. The systems and methods obtain a plurality of reference images from a plurality of samples under known conditions, provide each of the plurality of reference images to an image recognition algorithm and generate a historical database of reference images to be used in real-time. The system can obtain real-time samples, render spectral images of the sample's composition, and use the image recognition algorithm to compare the overall shape of the image to the overall shapes in the reference images to determine if they match to within a threshold value. Upon a positive determination that the images match within a threshold value, an alert can be sent to the supervisor of an environment to warn them of the onset of a known condition. In some examples, counter-measures can be employed to alleviate certain known conditions. In one example, a method is provided for analyzing spectrograms of samples from a livestock environment (e.g., a setting with a group of animals in artificial conditions). The method utilizes at least one recorded spectrogram of a sample from the targeted condition environment and compares this spectrogram with sets of pre-recorded/captured spectrograms of known conditions that originate from the same or from a highly comparable setting. The visual representation of the spectrograms is rendered as a two-dimensional or multi-dimensional image, and is evaluated, compared, and quantified by using image comparison techniques.

One advantage of such a system is that there is no need for identifying the individual compounds (e.g., biomarkers) nor their concentration in the sample, to reach a conclusion on the condition of the animal or plant population and take appropriate action. Although the description that follows may focus on embodiments that use air sampling and gas analysis (detecting a.o. biomarkers), the suggested methods and systems apply equally to any type of sample and analysis method.

As set forth below in detail, the present disclosure proposes use of each spectrogram as a unitary image as the single source of information of a condition (of e.g. an animal, a plant, an animal population, plant group, a livestock stable, greenhouse). Thus, rather than deducing from such spectrogram the detailed composition of the analyzed sample (e.g. a gas sample), the present disclosure relies on the shape (two-dimensional, three-dimensional, or multi-dimensional representation) of each spectrogram or one or more selected characteristics of that spectrogram to deduce information of the condition of the animal, plant, animal population, plant group, stable or greenhouse. By doing so, multiple (all that are captured in one or more spectrograms) biomarkers will be considered, even if these are not known to be relevant biomarkers. Also, a combination of biomarkers and interdependencies between these are also considered using this approach.

In one aspect, the systems and methods described use recorded spectrograms of a collected sample of the targeted condition and compare this spectrogram with sets of pre-recorded captured spectrograms of known conditions that originate from the same or from a highly comparable setting. For example, these pre-recorded captured spectrograms can originate from historical data of earlier outbreaks or conditions that have been purposefully induced within a given entity population to yield an image or images of dynamic spectra, and these spectra can be linked to the induced outbreak or condition for analysis and use later in real-time. The visual representation of the spectrograms is being interpreted as two-dimensional or multi-dimensional images, and is evaluated, compared, and quantified by using image comparison techniques. One might add additional spectrograms of the same sample but with different apparatus settings to make the method more powerful. Or adding spectrograms of the same sample but obtained by another method. Additionally, sequences of images and its changes in time captured from a certain evolving condition in e.g. a livestock stable, are used as a kind of calibration curve (comparable to using references samples of varying concentration in chemistry as to define the concentration of a sample with unknown concentration).

In one aspect, air samples of a livestock stable are collected and analyzed by e.g. a gas chromatograph (GC). The obtained GC data (or a set of regularly repeated GC data) are compared with sequences of historical GC data from a comparable stable, in which, certain (unwanted) events have evolved, such as e.g. a situation of heat stress that resulted in high animal mortality, the outbreak and evolution of a disease which would be expected to give rise to changing environmental parameters or changing biomarkers from the affected animals, etc. It should be noted that, although the description of the method discussed below relates to VOC biomarkers, the method is also relevant for any type of observable marker and for any type of spectrogram.

Stress levels in e.g. broiler chicken population can have a large impact on breeding efficiency and animal mortality. Stress might be related to unwanted conditions in the stable, such as environmental external triggers such as e.g. sudden sounds, heat or cold, too high concentration of birds, etc. There are various known VOCs related to stress conditions, however studies are mainly limited to humans. Comparable VOCs are expected for animals such as chicken. Often in chicken populations, non-VOC stress biomarkers are used, such as e.g. Heterophil/Lymphocyte ratio. The methodology described herein removes the requirement of having a deep understanding in such VOCs and additional scientific studies. The suggested approach is to create various levels of ‘stress’ conditions in the animal population by using animal stressors, such that spectrogram reference images and calibration data are generated. The type of referencing/calibration data is defined by looking at the spectrograms (e.g. from a gas chromatography analysis of air samples) and to extract from the spectrogram the key changing elements versus the stress condition level.

Using such referencing method, the animal population's condition can be monitored on a regular basis by capturing spectrograms of the stable and comparing these with the calibration data. Such comparison is preferably done by using an automated algorithm. Small and/or low-cost sensing mechanisms may be integrated in the infrastructure of the environment, e.g., a stable. One or multiple sensing mechanisms can be implemented. Data processing can be done on edge within or proximate to the environment or via a remote server through the internet or the cloud. Additionally, in office lighting systems, one or more luminaires with embedded or integrated sensor modules or sensing mechanisms provide both aggregated data (e.g. people count, temperature) and non-processed data (e.g. presence detection) to a gateway that can support a plurality of individual nodes, e.g., approximately 200 nodes. Multiple gateways can be connected to a lighting management server (for and entire office building level) that could be installed or located on premises or on a remote server over the internet or cloud. The management system can also support multiple office buildings. A similar approach and system design can be utilized for various agriculture or farming environments as will be described below.

In one example, a method of detecting a condition in an environment is provided, the method including: obtaining, via a sensing mechanism, at least one sample taken from the environment; rendering, via a processor, at least one image associated with the at least one sample; comparing, via the processor, the at least one image of the at least one sample to a plurality of reference images related to a condition within the environment; and detecting an onset of the condition within the environment when the at least one image of the at least one sample and at least one reference image of the plurality of reference images match to within a threshold value.

In one aspect, the method further includes: obtaining a plurality of samples taken from the environment while at least one entity from within the environment is experiencing the condition; rendering at least one reference image of the plurality of reference images from each of the plurality of samples taken from the environment; associating each of the at least one reference image with the condition; and generating a historical database of reference images correlating each reference image to the condition.

In one aspect, comparing the at least one image to the plurality of reference images includes comparing a plurality of images of at least one sample taken over a first time period with each of the plurality of reference images.

In one aspect, the at least one image includes at least one characteristic or feature and wherein each reference image of the plurality of reference images includes at least one characteristic or feature.

In one aspect, the at least one characteristic or feature is selected from at least one of: an area above a curve provided in the at least one image or reference image, an area below the curve, at least one local maximum or peak, at least one local minimum or valley, an overall shape of the curve, a slope of at least a portion of the curve, total number of local maximums or peaks, total number of local minimums of valleys, a maximum intensity value, or the relative position of one or more peaks or valleys. Characteristics or features can be real or derived, for instance principal components.

In one aspect, comparing the at least one image to the plurality of reference images includes comparing the at least one characteristic or feature of each of the plurality of reference images to the at least one characteristic or feature of the at least one image.

In one aspect, the environment is selected from at least one of: a greenhouse, a pond, a sea cage, an office space, a prison, an assisted living facility, a hospice facility, a barn, a chicken coop, or a livestock stable.

In one aspect, the sensing mechanism is selected from at least one of: a biosensor, a biomarker sensor, a chemical sensor, an Infrared (IR) sensor, a camera, a microphone, an air composition sensor, a gas chromatograph, liquid chromatograph, a mass spectrometer, or a micro gas chromatography system.

In one aspect, the condition is selected from a stress condition or the outbreak of a disease.

In one aspect, the method further includes: sending an alert based on a positive detection of the onset of the condition.

In another example, a system for detecting a condition in an environment is provided, the system including a sensing mechanism configured to obtain at least one sample taken from the environment and a processor. The processor is configured to: render at least one image associated with the at least one sample; compare the at least one image of the at least one sample to a plurality of reference images related to a condition; and detect an onset of the condition within the environment when the at least one image and at least one reference image of the plurality of reference images match to within a threshold value. In one aspect, the processor is configured to compare a plurality of images taken over a first time period with the plurality of reference images associated with the condition.

In one aspect, the at least one image includes at least one characteristic or feature and wherein each reference image of the plurality of reference images includes at least one characteristic or feature.

In one aspect, the at least one characteristic or feature is selected from at least one of: an area above a curve provided in the at least one image or reference image, an area below the curve, at least one local maximum or peak, at least one local minimum or valley, an overall shape of the curve, a slope of at least a portion of the curve, total number of local maximums or peaks, total number of local minimums of valleys, a maximum intensity value, or the relative position of one or more peaks or valleys.

In one aspect, the processor is further configured to send an alert based on a positive detection of the onset of the condition.

In one aspect, the processor is further configured to deploy at least one counter-measure to alleviate the condition.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a schematic view of a system according to the present disclosure.

FIG. 2. Illustrates a schematic representation of the components of a device according to the present disclosure.

FIG. 3A illustrates a reference image according to the present disclosure.

FIG. 3B illustrates a reference image according to the present disclosure.

FIG. 3C illustrates a reference image according to the present disclosure.

FIG. 3D illustrates a reference image according to the present disclosure.

FIG. 4A illustrates an image according to the present disclosure.

FIG. 4B illustrates an image according to the present disclosure.

FIG. 4C illustrates an image according to the present disclosure.

FIG. 5A illustrates a reference image according to the present disclosure.

FIG. 5B illustrates a progression of images according to the present disclosure.

FIG. 6 is a flow chart illustrating steps of a method according to the present disclosure.

FIG. 7 is a flow chart illustrating steps of a method according to the present disclosure.

### DETAILED DESCRIPTION OF EMBODIMENTS

The present disclosure is related to methods and systems for detection and alerting of a known condition within an environment. The systems and methods obtain a plurality of reference images from a plurality of samples under known conditions, provide each of the plurality of reference images to an image recognition algorithm and generate a historical database of reference images to be used in real-time. The system can obtain real-time samples, render spectral images of the sample's composition, and use the image recognition algorithm to compare the overall shape of the image to the overall shapes in the reference images to determine if they match to within a threshold value. Upon a positive determination that the images match within a threshold value, an alert can be sent to the supervisor of an environment to warn them of the onset of a known condition. In some examples, counter-measures can be employed to alleviate certain known conditions.

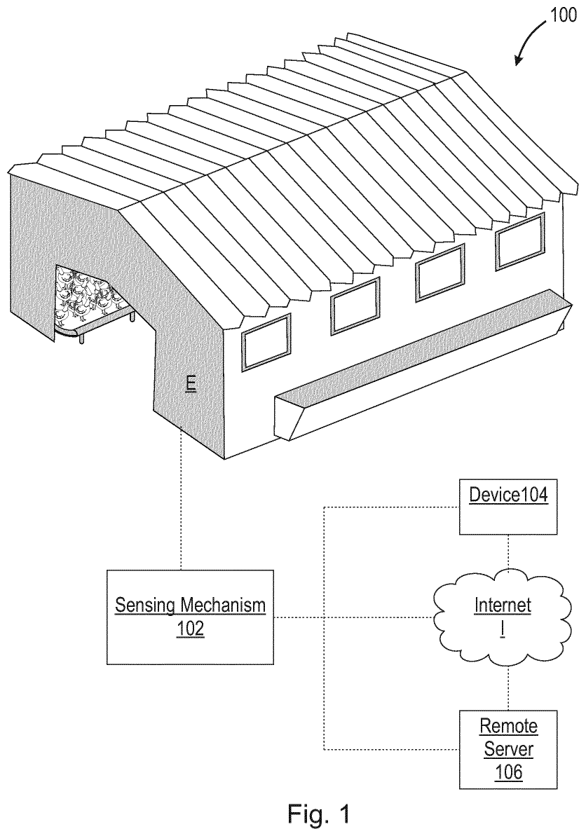

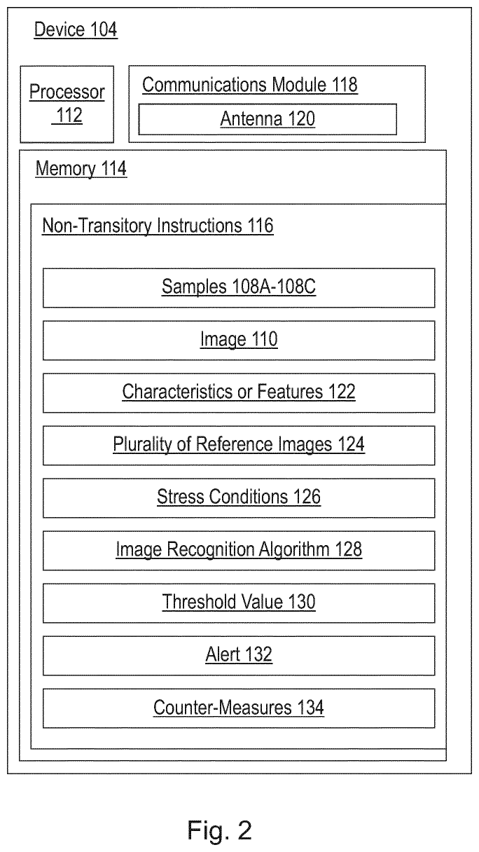

The following description should be read in view of FIGS. 1-5B. FIG. 1 illustrates a schematic view of system 100 within environment E according to the present disclosure. System 100 includes at least one sensing mechanism 102 and at least one device, e.g., device 104 and/or remote server 106. Environment E is intended to be an environment that includes livestock, plants, aquatic species, or people. In some examples, environment E is a barn, a livestock stable, a chicken farm or chicken coop, a greenhouse, a pond, a sea cage, or any agricultural environment that includes plants, aquatic species, animals, or other entities capable of producing some form of biomarker (discussed below). In some examples, a pond environment may include shrimp or fish populations. In other examples, a sea cage environment may be used for salmon populations or other large aquatic fish or mammals. In some examples, environment E can include people, i.e., where the people are the entities capable of producing various behaviors or biomarkers indicative of a condition. For example, environment E may include environments populated by people that are continuously kept under comparable conditions, e.g., office spaces, prison populations, assisted living facilities, hospice care, etc., where people typically consume comparable foods and/or exhibit comparable behaviors. In these environments, as will be described below, system 100 can be utilized to detect the onset of a contagious disease, e.g., bacterial pneumonia, various flu strains (e.g., COVID-19), tuberculosis, etc. As will be discussed below in detail, system 100 is configured to analyze real-time sample data from environment E, compare the real-time sample data to historical data associated with certain conditions, and generate a warning or alert indicative of the onset of one of these conditions within environment E. Additionally, in some examples, system 100 can be configured to employ various counter-measures 134 (shown in FIG. 2) in an attempt to alleviate the detected condition upon sending of the alert.

Sensing mechanism 102 is intended to be a device capable of obtaining a plurality of samples, i.e., samples 108A-108C (collectively referred to herein as “samples 108” or “plurality of samples 108”) from environment E. In some examples, sensing mechanism 102 can be selected from at least one of: a biosensor, a biomarker sensor, a chemical sensor, an Infrared (IR) sensor, a camera, a microphone, an air composition sensor, a gas chromatograph, liquid chromatograph, a mass spectrometer, or a micro gas chromatography system, or any device, spectroscopic or analytical tool capable of obtaining and analyzing a sample 108 from environment E. It should also be appreciated that any of the foregoing sensors or systems can be combined in any conceivable way to form sensing mechanism 102. Sensing mechanism 102 can further include circuitry configured to render at least one image 110, e.g., images 110A-110C (collectively referred to herein as “images 110” or “plurality of images 110”) using data from each sample 108, and/or potentially send data collected from the sample 108 to a separate device, e.g., device 104 and/or remote server 106, so that the separate device can use the data to render at least one image 110. As will be discussed below, samples 108 can take various forms, thus images 110 can take the form of a spectral image, or image representing a spectrum of values, e.g., a spectrogram, audiogram, photograph, etc., that corresponds to the appropriate sample type taken from environment E. Spectral or spectrum, in addition to its ordinary meaning to those skilled in the art, is intended to mean data represented across a continuous set of values as a function of one or more independent continuous factors. Samples 108 can take the form of at least one of: gas or air taken from within environment E; fecal matter of one or more entities within environment E; blood or saliva from one or more entities within environment E; photographs or light sensor measurements (e.g., light within the infrared or ultraviolet spectrums of electromagnetic radiation); sound recordings from within environment E; or any other sample matter obtainable from the entities within environment E that can contain one or more biomarker. In some examples, the samples and sensor measurements can include other forms of measurement, e.g., radio deflection and ranging sensor measurements (RADAR), light detection and ranging (LIDAR), or measurements outside of the visible spectrum of electromagnetic radiation.

Device 104 is intended to be a computational device, e.g., a portable or desktop personal computer (PC), a tablet, a smart phone, or other computational device capable of interfacing with sensing mechanism 102 and/or a human operator or user. In some examples, as illustrated schematically in FIG. 2, device 104 can be a personal computer or other computational device that comprises a processor 112 and memory 114, configured to execute and store, respectively, a set of non-transitory computer-readable instructions 116 to perform the various functions of device 104 as will be discussed herein. In some examples, device 104 can further include a communications module 118 configured to send and/or receive wired or wireless data, e.g., data related to each sample 108, to and/or from sensing device 102 and/or remote server 106 (discussed below). To that end, communications module 118 can include at least one radio or antenna, e.g., antenna 120 capable of sending and receiving wireless data. In some examples, communications module 118 can include, in addition to at least one antenna (e.g., antenna 120), some form of automated gain control (AGC), a modulator and/or demodulator, and potentially a discrete processor for bit-processing that are electrically connected to processor 112 and memory 114 to aid in sending and/or receiving wireless data. In some examples, processor 112 and memory 114 are configured to received wired or wireless data from sensing mechanism 102 associated with a plurality of samples 108, and generate one or more images, i.e., images 110, illustrative of the real-time composition of samples containing various biomarkers or other compounds within environment E. As will be discussed below, these images 110 may be compared to historical data, i.e., reference images 124 related to known conditions in environment E, to detect the onset of any known condition. In other examples, device 104 is configured to send, over the internet I, the data associated with the plurality of samples 108 to a remote server, e.g., remote server 106, such that the processing and comparison may be performed remotely from environment E. As such, remote server 106 can includes similar circuitry and components as set forth above with respect to device 104, e.g., a processor, memory, set of non-transitory computer readable instructions, etc.

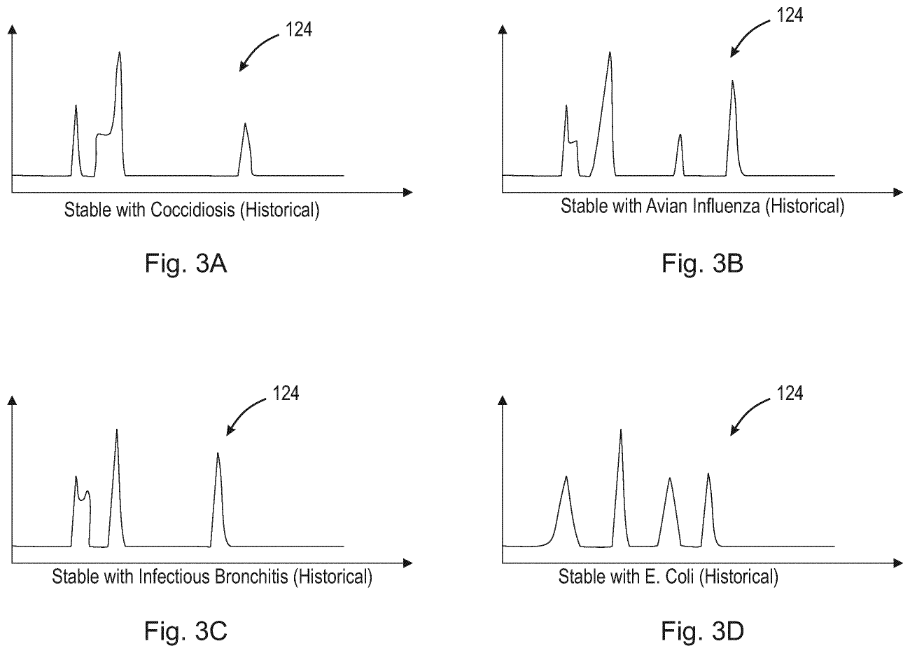

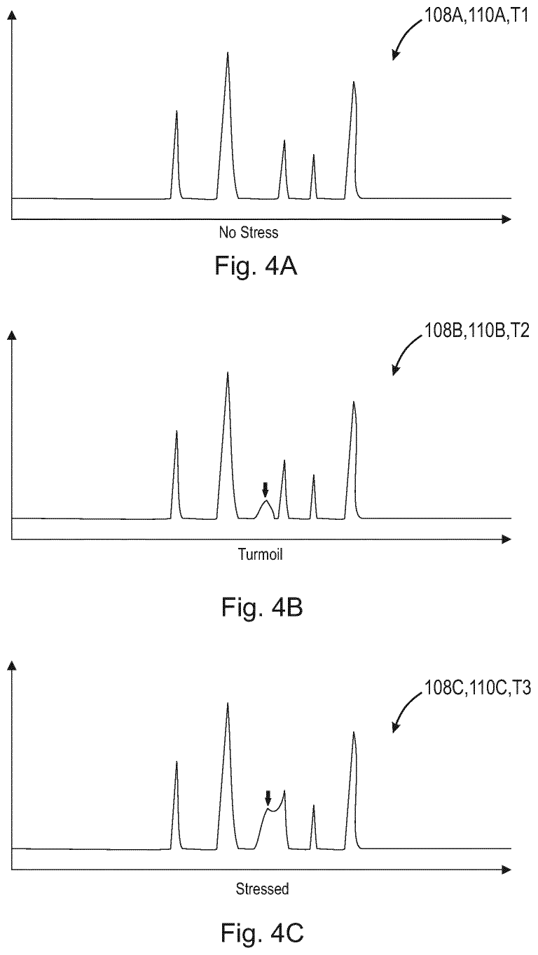

As mentioned above, sensing mechanism 102 is configured to receive one or more samples, e.g., samples 108A-108C (shown in FIGS. 4A-4C) from environment E and analyze each sample 108 to render an image 110 associated with the respective compositions of each sample. Although illustrated in FIGS. 4A-4C as spectrograms, it should be appreciated that images 110 (as set forth above) can take the form of a spectrogram, audiogram, photograph, etc., that corresponds to the appropriate sample type taken from environment E. Additionally, although illustrated as a two-dimensional spectrogram, it should be appreciated that the images 110 rendered by system 100 can be two-dimensional images, three-dimensional images, or multi-dimensional or multi-spectral images. In one example, as shown in FIGS. 3A-5B, sensing mechanism 102 is a gas-chromatograph and/or a gas-chromatograph and mass-spectrometer configured to generate at least one image 110 in the form of a two-dimensional spectrogram indicative of the spectral composition of a sample 108. The spectral composition shown in each image 110, can include various characteristics or features 122, e.g., local relative maximums (peaks), local relative minimum values (valleys), etc. As shown, each peak or spike in the spectrogram may be indicative of a high concentration of a particular compound, hormone, or other biomarker from within the sample. In some examples, the plurality of characteristics or features 122 can include at least one of: an area above a curve, an area below the curve, at least one local maximum or peak, at least one local minimum or valley, an overall shape of the curve, a slope of at least a portion of the curve, total number of local maximums or peaks, total number of local minimums of valleys, at least one maximum intensity value, the relative position of one or more peaks or valleys, or the intensity ratios of one or more peaks.

Prior to operation of system 100, the present disclosure sets forth methods for establishing baseline, calibration, and/or historical data related to at least one of a plurality of conditions 126 within the environment E. For example, during a calibration phase, system 100 may be employed within one or more large-scale broiler-chicken stables, farms, or coops. Throughout the calibration phase, system 100 can be configured to take a plurality of samples 108 (which can range from dozens of samples to hundreds of thousands of samples taken from one or more environments) and render a respective plurality of reference images 124 taken under normal conditions, i.e., where no stress condition 126 (discussed below) is present within each environment E. Additionally, during the calibration phase, system 100 can be configured to collect reference images 124 related to samples taken under known stress conditions 126 for a particular entity and preserve or otherwise save those reference images 124 in a historical database for use by system 100 during its operational phase (discussed below). For example, as illustrated in FIGS. 3A-3D, samples may be taken and a collection of historical reference images 124 can be correlated to various identified stress conditions 126, e.g., various known diseases or other stressors, and stored in a historical database for comparison later in real-time. As shown in FIGS. 3A-3D, stress conditions 126 can relate to an outbreak of various diseases within a given entity population. For example, FIG. 3A illustrates a schematic representation of a rendered two-dimensional spectrogram from a gas sample of a broiler-chicken stable that is indicative of an outbreak of Coccidiosis, i.e., a parasitic disease of the intestinal track in animals. FIG. 3B illustrates a schematic representation of a rendered two-dimensional spectrogram from a gas sample of a broiler-chicken stable that is indicative of an outbreak of Avian Influenza. FIG. 3C illustrates a schematic representation of a rendered two-dimensional spectrogram from a gas sample of a broiler-chicken stable that is indicative of an outbreak of Infectious Bronchitis. FIG. 3D illustrates a schematic representation of a rendered spectrogram from a gas sample of a broiler-chicken stable that is indicative of an outbreak of E. Coli. Other stress conditions 126 can be sampled, e.g., broiler-chickens may experience stress conditions while being fed or being caught, as the presence of a farmer or caretaker typically stirs chickens into an agitated or stressed state. Other environmental conditions may trigger stress conditions 126, e.g., sudden noises or sounds, high temperatures, low temperatures, excessively high concentrations of entities within a given space, etc.

As shown in FIGS. 3A-3D, while stressed, i.e., under stress conditions 126, the entities within environment E (e.g., broiler-chickens, plants, people, etc.) can produce various volatile organic compounds (VOCs), e.g., through exhalation, related to each known stress condition 126 that will present within the spectrograms illustrated through dynamic changes in the spectra over time. The known spectrograms have a particular configuration or overall shape that includes the position, concentration, or intensities of each compound present in the sample, where one or more compounds present may represent a VOC. Without needing to appreciate the causal link between the presence or absence of each compound, or which compound may be a VOC, the overall features or characteristics 122 of the spectral curve produced can be compared to images 110 in real-time (discussed below) to determine if a known condition exists within environment E. As mentioned above, during the calibration phase, potentially hundreds of thousands of reference images 124 may be rendered and stored. Each reference image 124 may be labeled or otherwise associated with particular known stress conditions 126. It should be appreciated that the historical database of reference images 124 can be generated directly by system 100 during the calibration phase or can be imported from multiple sources and multiple environments and compiled into a central database for use during the operational phase discussed below. Additionally, in some circumstances, the stress conditions 126 can be artificially induced to enable sampling and labelling of known stress conditions with certainty.

During an operational phase, samples can be taken and rendered into images 110 in real-time and compared to the plurality of reference images 124 to determine if any of the known stress conditions 126 exist or are developing within environment E. Samples 108 and their associated images 110 can be taken and/or rendered once a day, multiple times a day, once an hour, once a minute, etc., and can be automated using software or some form of algorithm. It should be appreciated that samples 108 can be taken at a plurality of different time periods or intervals and that the examples above should not be construed as limiting. In real-time, each image 110 rendered by device 104 and/or via remote server 106, can be analyzed, e.g., using an image recognition algorithm 128 to compare one or more characteristics or features 122 of each image 110 to one or more characteristics or features 122 of at least one of the plurality of reference images 124 stored during the calibration phase. Each image 110 is compared in its entirety to each of the plurality of reference images 124 to determine if the image 110, or the curve within the image 110, matches at least one reference image 124, or the curve within at least one reference image 124, within a predetermined threshold value 130. For example, where area under a given curve (AUC) is determined and compared to the area under the curve of a reference image 124, the threshold value 130 may be between 0.1-0.2. In some examples, the threshold value may be selected from a range between 0.01-0.05. In an example where a maximum intensity of a particular peak is utilized, the threshold value may be dependent on statistical information derived from the reference images, e.g., four times the standard deviation of intensity values. Additionally the largest maximum or peak may be within 1%, 2%, 5%, 10%, 15%, 20%, or 30% of the largest maximum peak of a particular reference image. In some examples, the image recognition algorithm 128 (discussed below) derives implicitly defined threshold values during a training phase. As will be discussed below, in some examples, all of these characteristics or features 122 are considered and compared simultaneously by analyzing the images in their entirety, without focusing on one or two singular features.

Image recognition software or algorithm 128 is intended to be one or more algorithms trained to visually analyze and extract or identify a plurality of characteristics and features 122 from image 110 in real-time and compare those characteristics and features 122 to the characteristics and features 122 of the plurality of reference images 124 provided in a historical database that are associated with known stress conditions 126. Each image, e.g., each spectrogram or audiogram, can include a multi-component continuous spectrum, i.e., where a single curve or line can represent the presence or absence of particular quantities or concentrations of various compounds within the sample. Importantly, during a training phase of image recognition algorithm 128, the algorithm can be presented with a plurality of reference images 124 (up to hundreds of thousands of reference images) from multiple environments, e.g., multiple farms, so that the algorithm can learn to identify the overall shape of the curves or lines produced by the reference sample spectrograms and associate those particular shapes with known conditions. The image recognition algorithm 128 can utilize various image processing or image recognition techniques to analyze a given image, including, for example, principle component analysis. Importantly, once trained, the algorithm does not rely on the presence or absence of a single VOC, rather it relies on the entire spectrogram as a single unitary image to be compared to new images in real-time. It should be appreciated that, although described as a supervised training model, i.e., a model that is provided with pre-labeled images, it should be appreciated that algorithm 128 may utilize an unsupervised learning model during training. As the trained algorithm 128 does not necessarily identify the presence of a particular stress condition through causal knowledge of the presence of certain compounds, and instead uses the overall shape or outlines of each image spectrogram in real-time as an indicator of a potential condition, the present systems and methods do not require knowledge of the causal link between concentrations of certain compounds, multiple compounds, or the ratios of various compounds with respect to each other. Instead, all of these characteristics or features can be considered in the comparison of the overall shape or outline of the curve generated. This approach allows for cheaper, lower-resolution sensors to be employed as the accuracy of detection of each component individually becomes less important.

During the operational phase, if the image recognition algorithm 128 determines that a particular image 110 taken in real-time matches at least one reference image 124 of the plurality of reference images 124 stored during the calibration phase within a threshold value 130, it is assumed that the stress condition 126 associated with the at least one reference image 124 is present within environment E. Importantly, this determination is made solely with the use of image recognition algorithm 128 on the images 110 rendered by device 104 and/or remote server 106, and does not require an understanding of the causal relationship between the presence or absence of a particular compound or VOC and/or the link between a particular VOC and a particular stress condition 126. In the event that a sample and corresponding image 110 are determined to match at least one reference image 124 within threshold value 130, device 104 and/or remote server 106 can be configured to send an alert 132 to one or more individuals or further devices to alert users of the system that a particular condition has been detected within the environment E.

Furthermore, in some examples, a plurality of images 110 can be compared to the plurality of reference images 124 over a period of time so that the rate of evolution of a stress condition 126 can be analyzed and factored into whether an alert is sent. For example, plurality of reference images 124, obtained during the calibration phase, may include meta data, time stamps, or other information indicative of when the reference images 124 were taken relative to the progression or onset of a particular known disease or stress condition 126, e.g., there may be a progression of reference images taken over a period of time (e.g., over a period of 9-10 days) illustrating the development and progression of Infectious Bronchitis from a first point in time where no condition or disease is present, to a second point in time when the disease or condition has spread through a significant portion of the entity population. In other examples, i.e., when using audio samples and rendering audiograms, stress conditions may present themselves as sudden or abrupt spikes or deviations in the audio patterns and would require analysis of shorter time intervals, i.e., rather than over several days, the analysis may take place over several minutes or even several seconds.

For example, as illustrated in FIG. 4A, which illustrates a schematic representation of a rendered first image or spectrogram 110A from a first gas sample 108A of a broiler-chicken stable at a first point in time T1, analysis of the curve and features and characteristics 122 of this spectrogram via image recognition algorithm 128 would likely not indicate any known stress condition as it would likely not match any of the plurality of reference images 124 within a threshold value 132. FIG. 4B, which illustrates a schematic representation of a second rendered spectrogram 110B from a second gas sample 108B of a broiler-chicken stable at a second point in time T2 (e.g., 3-5 days after first point in time T1), shows a slight increase in the concentration of a particular compound (shown by a solid arrow). This slight increase may factor into the overall image recognition analysis of second image 110B, and indicate to the system a slight turmoil within the entity population, i.e., the early onset of a stress condition 126. FIG. 4C, which illustrates a schematic representation of a third rendered spectrogram 110C from a third gas sample 108C of a broiler-chicken stable at a third point in time T3 (e.g., 3-5 days after second point in time T2), shows a significant increase in the concentration of a particular compound (shown by a solid arrow). This significant increase in a single VOC, will change the overall shape or outline of the rendered spectrogram, which will be compared to the overall outlines of reference images 124 and indicate to the system that the entity population is sufficiently stressed to initiate an alert 132.

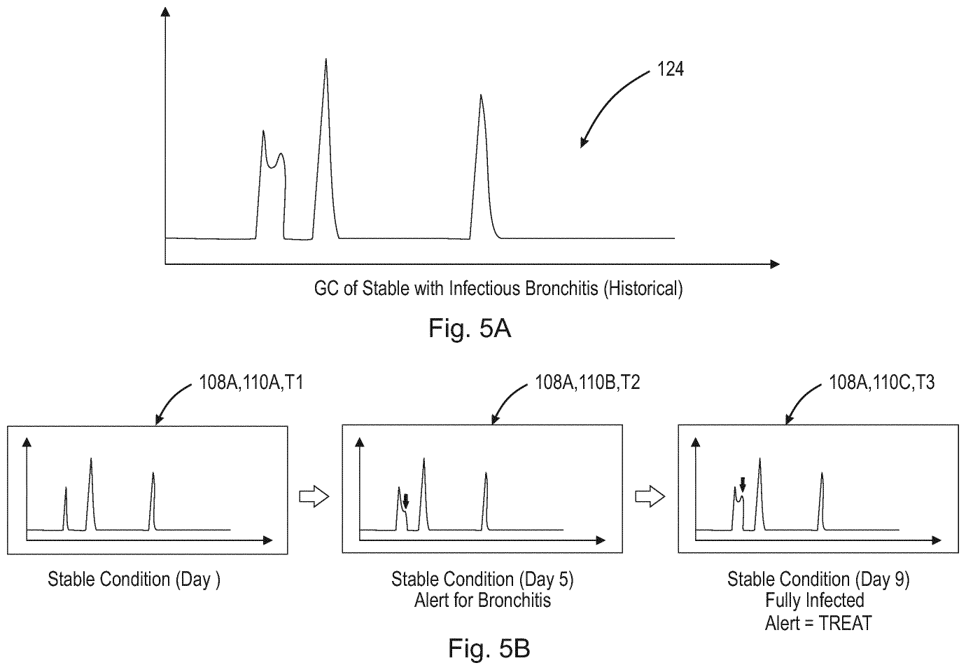

In another example implementation, shown in FIGS. 5A-5B, a similar analysis of the evolution of a developing condition over time of a particular stress condition 126 is provided, where the stress condition 126 is the onset of Infectious Bronchitis in a broiler-chicken population. FIG. 5A is an example reference image 124 stored during the calibration phase that has been labelled or otherwise associated with an outbreak of Infectious Bronchitis in a broiler-chicken population. FIG. 5B illustrates a progression of a plurality of images 110A-110C, rendered from a plurality of samples 108A-108C, over a period of time. For example, image 110A, rendered from an initial sample 108A within environment E at a first point in time T1, illustrates a stable, un-stressed condition. Image 110B, rendered from a second sample 108B within environment E at a second point in time T2 after the first point in time (e.g., 5 days after T1), illustrates the beginning of the onset of Infectious Bronchitis within the entity population of broiler-chickens (indicated by a spike or peak in a particular VOC or compound indicated by a solid arrow). Image 110C, rendered from a third sample 108B within environment E at a third point in time T3 after the second point in time T2 (e.g., 9 days after T1), illustrates an outbreak of Infectious Bronchitis within the entity population of broiler-chickens (indicated by a spike or peak in a particular VOC or compound indicated by a solid arrow). In the example illustrated, an alert 132 can be sent to a farmer, caretaker, or other supervising entity of environment E to warn or alert them of the onset of a stress condition 126, i.e., the onset of Infectious Bronchitis, as early as the second point in time T2 and no later than the third point in time T3. In some examples, an alert 132 indicative of the onset of Infectious Bronchitis (or any of the other stress conditions) is sent at second point in time T2, when the entirety of image 110B is compared to historical data and/or reference images and a positive determination is made that at least image 110B matches at least one reference image 124 within a threshold value 130. Although only one reference image 124 is shown for reference, it should be appreciated that a plurality of reference images 124 illustrative of the known, time-dependent, evolution and/or the progression of Infectious Bronchitis within a broiler-chicken population may be compared to the real time images 110A-110C to determine if an alert 132 is sent.

It should be appreciated that, although not illustrated, system 100, including sensing mechanism 102, device 104 and/or remote server 106, and image recognition algorithm 128 can be configured to obtain, analyze, and compare multiple images 110 simultaneously. For example, spectrograms rendered based on blood samples of entities within a particular environment can be compared to historical data and reference images 124 of blood samples of known conditions, while spectrograms rendered based on air samples of entities within the sample environment are compared to reference images 124 of air samples of known conditions, simultaneously. Similarly, spectrograms rendered based on fecal samples of entities within a particular environment can be compared to historical data and reference images 124 of fecal samples of known conditions, while audiograms rendered based on audio samples of entities within the sample environment are compared to reference audiograms 124 of audio samples of known conditions, simultaneously. It should be appreciated that any combination of two or more of these sample types and comparison techniques can be employed by system 100.

In some examples, and although not illustrated, system 100 may employ counter-measures 134 to alleviate certain stress conditions once an alert 132 is triggered. For example, upon detection or determination that a certain stress condition 126 exists within environment E, i.e., one or more images 110, rendered in real-time, match one or more reference images 124 of known stress conditions within a threshold value 130, the alert 132 generated may also serve to trigger deployment of one or more counter-measures 134 that are known to alleviate the particular stress condition 126 that exists in environment E. In some examples, these counter-measures 134 may be employed with direct human intervention or through automated systems (discussed below). In one example, detection of stressed broiler-chickens, e.g., the onset or outbreak of one or more diseases, stress caused by the presence of a farmer while feeding or catching chickens, high-temperature conditions, low-temperature conditions, over populations, etc., may be countered by various lighting effects from a plurality of luminaires positioned and/or dispersed throughout environment E. In these examples, i.e., where system 100 can include one or more luminaires, the light spectrum produced by each luminaire may be independently configurable such that the light spectrum provided to the entities within environment E has a soothing effect on the stressed entities. In one example, where system 100 determines the existence of an outbreak of a particular disease, discussed above, the luminaires of system 100 can be configured to produce wavelengths of electromagnetic radiation outside of the visible spectrum known to kill or aid in the destruction of various pathogens, e.g., ultra-violet (UV) light. Alternatively, system 100 can include one or more speakers or acoustic transducers capable of rendering audible sound within environment E, where the audible sound is capable of soothing or reducing the effects of a known stress condition 126. In some examples the triggering of an alert 132 may also trigger the activation of one or more fans, or other HVAC systems, to start, stop, increase, or decrease the circulation of air within environment E to reduce the spread of certain diseases or alleviate a particular stress condition 126. In some examples, triggering of alert 132 can trigger the increase or decrease in the temperature within environment E, e.g., using a thermostat connected to system 100. In some examples, triggering of alert 132 may also operate to dispense, disperse, or otherwise distribute medication, e.g., antibiotics to the entities within environment E based on the detected condition 126. In other examples, triggering of alert 132 can prompt, manual or automated removal of one or more specific entities from the population of entities within environment E that are likely to exhibit symptoms of the condition 126, e.g., if a specific chicken or group of chickens is known to have contracted a known disease.

In further examples, once alert 132 has been triggered and one or more counter-measures 134 discussed above have been deployed or utilized, further samples 108 can be taken and additional images 110 can be derived, such that system 100 can ensure that the appropriate counter-measure 134 has been deployed and/or that the condition 126 has been alleviated. If it is determined that one or more conditions 126 still exist even after the deployment of a particular counter-measure, one or more additional counter-measures 134 may be employed by system 100. This process may be iterative in that counter-measures 134 can be employed and additional samples can be taken until the condition 126 subsides or is completed removed from environment E.

The foregoing methods and systems can be utilized in various use cases, ranging from detection of heat stress, i.e., high-temperature conditions, through collection and analysis of gas samples within environment E, to the detection of various metabolic or bacterial or viral or parasitic or fungal diseases through fecal, blood, or saliva samples. Additional use cases may use light sensor or photograph samples to determine behavioral patterns of entities within the environment. The overt benefits of such systems and methods include, reduction in cost of alert systems related to detection of these conditions, the ability to use low-cost and lower-resolution sensors to detect the onset of the foregoing conditions, reduced analytical time in that it alleviates the need for intensive and costly studies to determine a causal link between particular VOCs within a given spectral sample and a stress condition 126, e.g., the onset of a particular disease or other stressor. The system allows for complete visual analysis of an entire spectral composition as a unitary shape and compares those shapes in real-time to the shapes of spectral compositions associated to known stress conditions to determine if something changes over time.

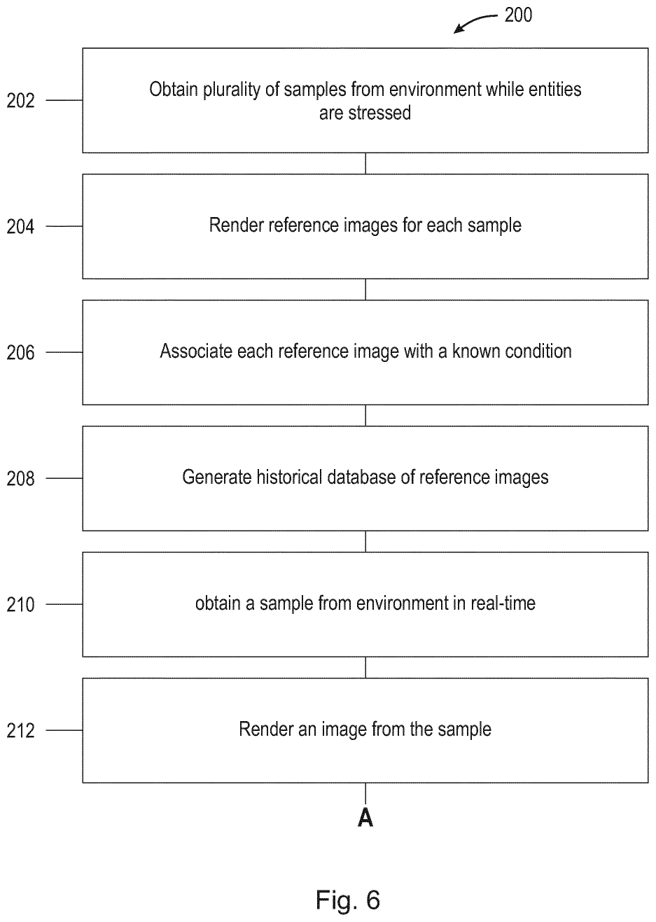

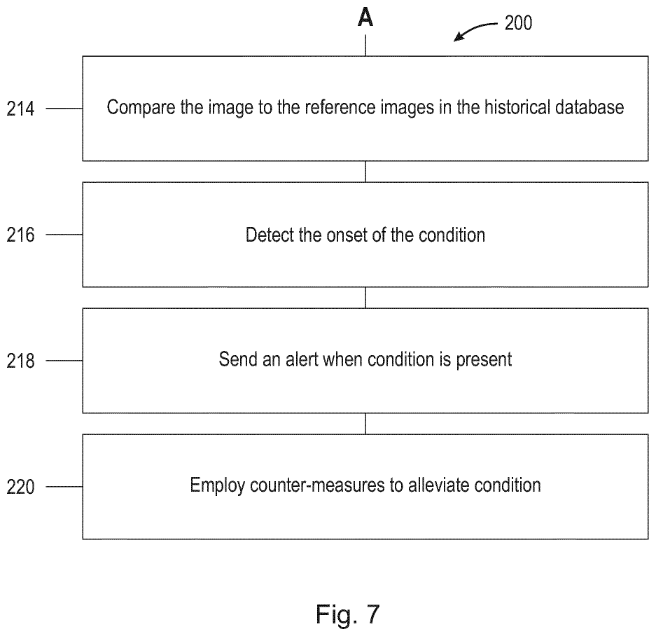

FIGS. 6 and 7 illustrate a flow chart corresponding to the steps of method 200 according to the present disclosure. As illustrated, method 200 can includes, for example: obtaining a plurality of samples 108 taken from an environment E while at least one entity from within the environment E is experiencing a condition 126 (step 202); rendering at least one reference image 124 of a plurality of reference images from each of a plurality of samples 108 taken from the environment E (step 204); associating each of the at least one reference image 124 with the condition 126 (step 206); generating a historical database of reference images 124 correlating each reference image 124 to the condition 126 (step 208); obtaining, via a sensing mechanism 102, at least one sample 108 taken from the environment E in real-time (step 210); rendering, via a processor 112, at least one image 110 associated with the at least one sample 108 (step 212); comparing, via the processor 112, the at least one image 110 of the at least one sample 108 to the plurality of reference images 124 related to the condition 126 within the environment E (step 214); detecting an onset of the condition 126 within the environment E when the at least one image 110 of the at least one sample 108 and at least one reference image 124 of the plurality of reference images match to within a threshold value 130. (step 216); sending an alert 132 based on a positive detection of the onset of the condition 126 (step 218); and employing counter-measures 134 to alleviate the condition 126 (step 220).

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A method of detecting a condition in an environment, the method comprising:
obtaining, via a sensing mechanism, at least one sample taken from the environment;
rendering, via a processor, at least one image associated with the at least one sample;
comparing, via the processor, the at least one image of the at least one sample to a plurality of reference images related to the condition within the environment;
determining, via the processor, a feature in the at least one image of the at least one sample matches within a threshold value to a feature in at least one reference image of plurality of reference images based on the comparison, wherein the threshold value includes a range of at least two values; and
detecting, responsive to the determination, an onset of the condition within the environment when the at least one image of the at least one sample and at least one reference image of the plurality of reference images match to within the threshold value.

2. The method of claim 1, further comprising:
obtaining a plurality of samples taken from the environment while at least one entity from within the environment is experiencing the condition;
rendering at least one reference image of the plurality of reference images from each of the plurality of samples taken from the environment;
associating each of the at least one reference image with the condition; and
generating a historical database of reference images correlating each reference image to the condition.

3. The method of claim 1, wherein comparing the at least one image to the plurality of reference images includes comparing a plurality of images of at least one sample taken over a first time period with each of the plurality of reference images.

4. The method of claim 1, wherein the at least one image includes at least one characteristic or feature and wherein each reference image of the plurality of reference images includes at least one characteristic or feature, wherein the at least one characteristic or feature is selected from at least one of: an area above a curve provided in the at least one image or reference image, an area below the curve, at least one local maximum or peak, at least one local minimum or valley, an overall shape of the curve, a slope of at least a portion of the curve, total number of local maximums or peaks, total number of local minimums of valleys, a maximum intensity value, or the relative position of one or more peaks or valleys.

5. The method of claim 4, wherein comparing the at least one image to the plurality of reference images includes comparing the at least one characteristic or feature of each of the plurality of reference images to the at least one characteristic or feature of the at least one image.

6. The method of claim 1, wherein the environment is selected from at least one of: a greenhouse, a pond, a sea cage, an office space, a prison, an assisted living facility, a hospice facility, a barn, a chicken coop, or a livestock stable.

7. The method of claim 1, wherein the sensing mechanism is selected from at least one of: a biosensor, a biomarker sensor, a chemical sensor, an Infrared sensor, a camera, a microphone, an air composition sensor, a gas chromatograph, liquid chromatograph, a mass spectrometer, or a micro gas chromatography system.

8. The method of claim 1, wherein the condition is selected from a stress condition or the outbreak of a disease.

9. The method of claim 1, further comprising:
sending an alert based on a positive detection of the onset of the condition.

10. A system for detecting a condition in an environment comprising:
a sensing mechanism configured to obtain at least one sample taken from the environment;
a processor configured to:
render at least one image associated with the at least one sample;
compare the at least one image of the at least one sample to a plurality of reference images related to the condition;
determine a feature in the at least one image of the at least one sample matches within a threshold value to a feature in at least one reference image of plurality of reference images based on the comparison, wherein the threshold value includes a range of at least two values; and
detect, responsive to the determination, an onset of the condition within the environment when the at least one image and at least one reference image of the plurality of reference images match to within the threshold value.

11. The system of claim 10, wherein the processor is configured to compare a plurality of images taken over a first time period with the plurality of reference images associated with the condition.

12. The system of claim 10, wherein the at least one image includes at least one characteristic or feature and wherein each reference image of the plurality of reference images includes at least one characteristic or feature.

13. The system of claim 12, wherein the at least one characteristic or feature is selected from at least one of: an area above a curve provided in the at least one image or reference image, an area below the curve, at least one local maximum or peak, at least one local minimum or valley, an overall shape of the curve, a slope of at least a portion of the curve, total number of local maximums or peaks, total number of local minimums of valleys, a maximum intensity value, or the relative position of one or more peaks or valleys.

14. The system of claim 11, wherein the processor is further configured to send an alert based on a positive detection of the onset of the condition.

15. The system of claim 14, wherein the processor is further configured to deploy at least one counter-measure to alleviate the condition.
